(19) United States
(12) Patent Application Publication
(10) Pub. No.: US 2010/0269365 A1
(43) Pub. Date: Oct. 28, 2010

(54) System and Method for Alternating Fluid Flow

(76) Inventors: Kenneth C. Miller, Fremont, CA (US); Mohammad Kazemi, Fremont, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 12/756,161

(22) Filed: Apr. 7, 2010

Related U.S. Application Data
(63) Continuation-in-part of application No. 12/122,571, filed on May 16, 2008.

(51) Int. Cl. F26B 13/30; F15D 1/00; F16K 21/00

(52) U.S. Cl. 34/239; 137/1; 137/597

(57) ABSTRACT

A chamber optimized for drying a substrate is provided. The chamber includes opposing sidewalls having fluid channels extending therethrough. The fluid channels deliver a fluid to interior inlet ports of the chamber. Outlet ports positioned below corresponding interior inlet ports are in communication with a vacuum source in one embodiment. A loop flow path extending into the interior of the chamber from opposing sides is provided. The loop flow path is swept across the interior of the chamber by alternating the fluid flow from the inlet ports or outlet ports.

### CROSS REFERENCE TO RELATED APPLICATION

This application is a continuation in part of U.S. application Ser. No. 12/122,571, filed on May 16, 2008. The disclosure of this prior application from which priority is claimed is incorporated herein by reference.

### BACKGROUND

In many manufacturing processes for semiconductor and magnetic disk manufacturing, it is necessary to treat a work piece in a liquid environment and then dry the work piece. As is well known, particulates or contaminates that attach during the drying process may eventually cause defects in the work piece. Additionally, an inefficient drying process may result in extended processing times or even leave defects on a surface of the work piece, as well as promote oxidation. Thus, it is extremely important that when a substrate is dried, there are no impurities left on its surface. In order to promote efficient drying and reduce the likelihood of forming impurities, the embodiments described below expose the work pieces to alternating distributed heated gas after the work pieces are removed from the liquid environment.

### SUMMARY

In one embodiment a chamber having a first wall and an opposing second wall, each wall having an outer surface and an opposing interior surface is provided. Each outer surface is formed with a first set of channels extending to the interior surface, each interior surface is exposed to an interior of the chamber and includes a plurality of interior ports in fluid communication with the first set of channels. A first flow controller and a second flow controller control a fluid flow to the interior ports through the first set of channels of the first and second walls, respectively. The first and second flow controllers each provide a loop flow path from the interior ports of the first and second walls. The loop flow paths are inversely varied across an interior width of the chamber such that a zone preventing moisture removal is moved as the loop flow paths are inversely varied through the first and the second flow controllers.

In another embodiment a drying system is provided. The drying system includes a chamber having first and second sidewalls and first and second end walls affixed to the first and second sidewalls. Interior surfaces of the first and second sidewalls have a plurality of inlet ports along an upper region of the interior surfaces and a plurality of outlet ports along a lower region of the interior surfaces. A fluid source in fluid communication with inlet ports of the first and second sidewalls is included. A vacuum source is in fluid communication with outlet ports of exterior surfaces of the first and the second sidewalls. The inlet ports of the first and second sidewalls are in fluid communication with the plurality of inlet ports along the upper region of the interior surfaces. The outlet ports of the first and the second sidewalls are in fluid communication with the plurality of outlet ports along the lower region of the interior surfaces, wherein a loop fluid flow is provided from each of the sidewalls. The loop fluid flow from the sidewalls flows toward an opposing loop fluid flow in an upper region of the chamber and away from each other in a lower region of the chamber.

In still another embodiment, a method for drying a workpiece is provided. The method includes flowing fluid into inlet ports of opposing sidewalls of a chamber, creating a loop flow path of the fluid that extends into the chamber from each of the opposing sidewalls, and inversely varying an extension of the loop flow paths into the chamber.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1 is a simplified schematic diagram illustrating an overview of a substrate cleaning system using a fluid distribution network in accordance with one embodiment of the invention.

FIG. 2 is an exemplary illustration of the drying chamber in accordance with one embodiment of the present invention.

FIG. 3 is an exemplary illustration of an exploded view of a portion of drying chamber in accordance with one embodiment of the present invention.

FIGS. 4A and 4B are exemplary views of the alignment of the vertical and horizontal channels of the vertical distribution plate and the horizontal distribution plate in accordance with one embodiment of the present invention.

FIGS. 5A and 5B are schematics showing the vertical distribution plate and the horizontal distribution plate in accordance with one embodiment of the present invention.

FIGS. 6A-6F are exemplary schematics illustrating various flow patterns that could be established within a chamber in accordance with embodiments of the present invention.

FIG. 7 is a flow chart illustrating exemplary operations for a method to evenly distribute a fluid within a chamber in accordance with one embodiment of the present invention.

FIGS. 8A-C illustrate various embodiments for sweeping the flow paths of FIG. 6C to further optimize the drying process in accordance with one embodiment of the invention.

FIG. 9 is a simplified schematic diagram illustrating an exemplary implementation to achieve the dual flow paths that sweep across the drying chamber in accordance with one embodiment of the invention.

FIG. 10 is a flow chart diagram illustrating the method operations for distributing fluid into a drying chamber disposed over a cleaning fluid in accordance with one embodiment of the invention.

### DETAILED DESCRIPTION

An invention is disclosed for alternating the dispensing and/or removing a fluid within a chamber. As described below, in one embodiment the fluid can be a gas to effectuate drying of substrate materials. However, the claims should not be construed to limit the type of fluid capable of being dispensed and/or removed within the chamber to drying gases. One skilled in the art should recognize that a chamber including the claimed subject matter could be modified to accommodate liquids or gases. Other embodiments include chambers that are able to switch between configurations for distributing gases to a configuration for distributing liquids. Additionally, while the description below describes a chamber for drying substrate materials, in other embodiments, the chamber may be scaled to include fluid circulation for larger structures such as clean rooms or entire buildings.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

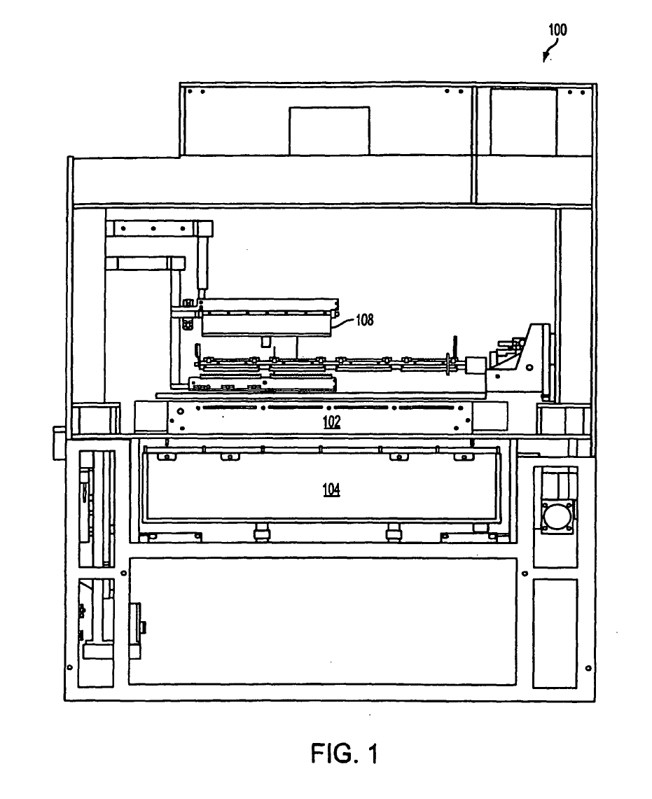

FIG. 1 is a simplified schematic diagram illustrating an overview of a substrate cleaning system 100 using a fluid distribution network in accordance with one embodiment of the invention. The substrate cleaning system 100 can include a drying chamber 102, a cleaning tank 104, and a transport assembly 108. After controlled exposure within the cleaning tank 104, substrate materials are moved via the transport assembly 108 to the drying chamber 102. For further information regarding the transport assembly 108, please see U.S. patent application Ser. No. 11/531,905, filed on Sep. 14, 2006 titled APPARATUS AND METHOD FOR DRYING A SUBSTRATE, which is herein incorporated by reference.

Heated drying gases are distributed throughout the length of the drying chamber 102 in an effort to provide uniform process exposure to the substrate materials. In order to achieve process uniformity, it is desirable to have uniform flow of the drying gases across the entire drying chamber to minimize temperature fluctuations within the drying chamber.

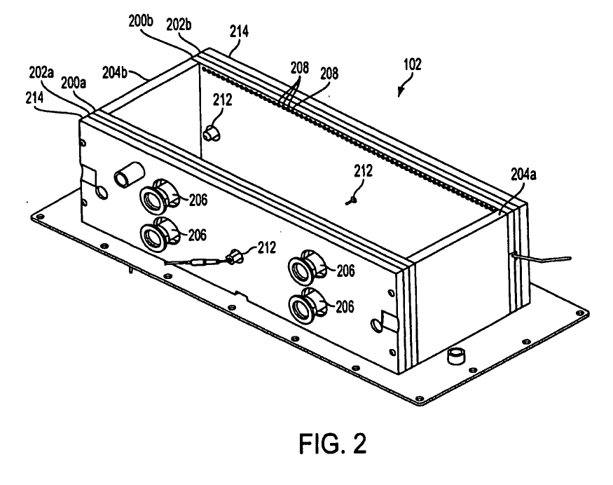

FIG. 2 is an exemplary illustration of the drying chamber 102 in accordance with one embodiment of the present invention. The interior of the drying chamber 102 is formed by horizontal distribution plates 200a/b and end walls 204a/b. As will be discussed below, the horizontal distribution plates 200a/b have horizontal channels or grooves formed on a surface to assist in the distribution of fluid throughout the drying chamber 102. Mated to the horizontal distribution plates 200a/b are vertical distribution plates 202a/b that will also be discussed in more detail below. As shown in FIG. 2, the horizontal distribution plate 200b can include ports 208 that are open to the interior of the drying chamber 102. Note that ports 208 are also found on the horizontal distribution plate 200a but are not visible in FIG. 2. In addition, a set of ports similar to ports 208 may be disposed along an opposing bottom surface of plates 200a and 200b. In one embodiment, the top and bottom ports of the same surface provide the loop flow described in more detail below.

In one embodiment of the drying chamber 102, heated drying gases are uniformly dispensed from ports 208 to minimize temperature variation within the drying chamber 102.

In other embodiments, gases at varying temperatures, mixtures of liquids at various temperatures, and mixtures of liquids and gases can be dispensed or removed from ports 208. Exterior walls 214 can be affixed to the vertical distribution plates 202a/b to provide insulation for embodiments where temperature control of the chamber is desired. The exterior walls 214 can also be used to increase the robustness of the chamber. The location, shape, and number of ports 208 shown in FIG. 2 are exemplary and should not be construed to limit the scope of the claims. Furthermore, the location, size, and configuration of the ports 208 can be modified as different uses of the chamber may require different fluid flow patterns and different fluid throughput in and out of the chamber.

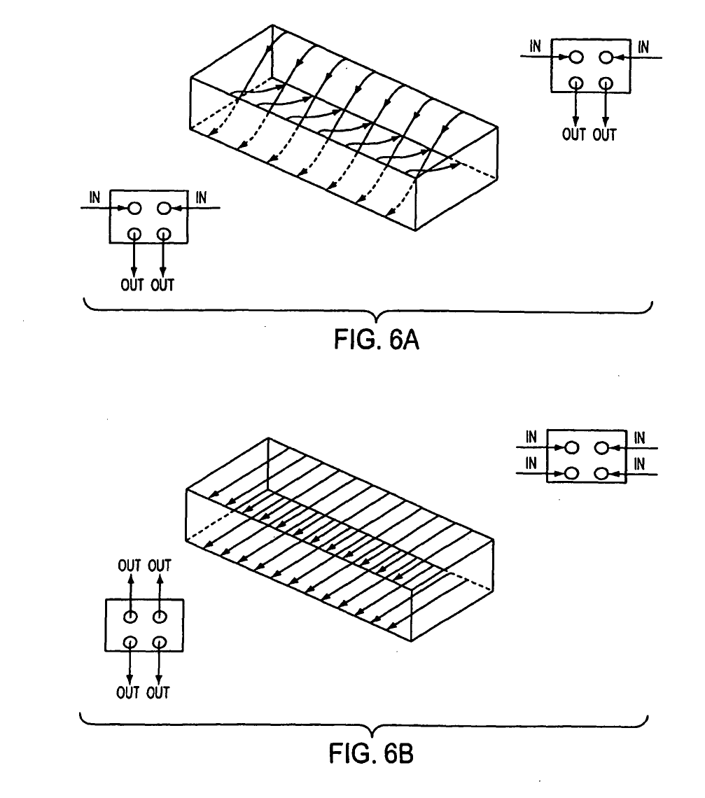

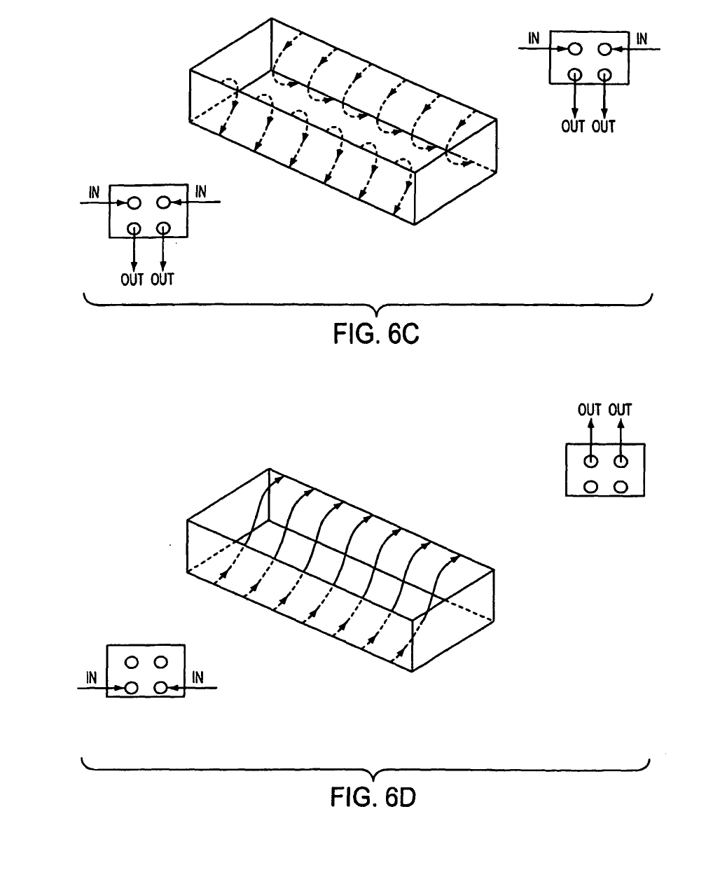

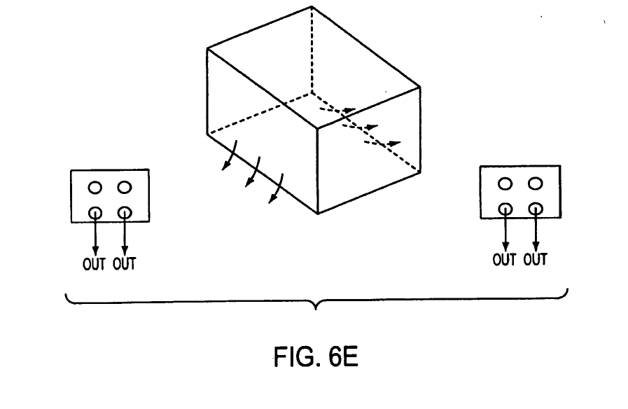

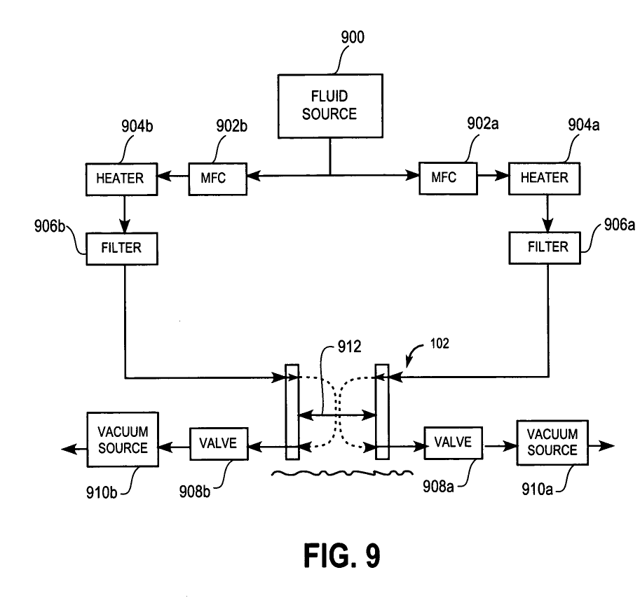

Vertical distribution plates 202a/b are laminated or secured to their respective horizontal distribution plates 200a/b. The vertical distribution plates 202a/b include vertical channels or grooves formed on a surface that is mated with the respective horizontal grooves of horizontal distribution plates 200a/b to assist in the distribution of fluid throughout the drying chamber 102. The vertical distribution plates 202a/b also include ports 206 that provide access to the vertical channels. In some embodiments, fluid supplies can be attached to ports 206 in order to distribute fluids to ports 208. In other embodiments, a vacuum can be attached to ports 206 in order to remove fluids through ports 208. The combination of fluid supply and vacuum can be used to circulate fluids within the drying chamber 102. In another embodiment, some of ports 206 may be utilized to supply fluid to ports 208, while the remainder of ports 206 may be utilized to provide vacuum to ports opposing ports 208 on a lower surface of the corresponding distribution plate. In this embodiment, a loop fluid flow is provided as described in more detail with reference to FIGS. 6C and 9.

As previously discussed, the chamber 102 can also be used to circulate liquids and combinations of liquid supply and return could be used to circulate liquids within a chamber as well. For example, cleaning tank 104 could use laminated walls to distribute and circulate cleaning liquids to facilitate the removal of contaminates from a work piece. The number of ports 206 can be configured based on each application and can vary depending on necessary throughput and the flow configuration within the chamber. In other embodiments where the chamber can be used for multiple processes, ports 206 can be opened and closed to modify the number of ports 206.

Both the vertical distribution plates 202a/b and the horizontal distribution plates 200a/b can also include additional ports 212 to provide access to the interior of the drying chamber 102. The ports 212 can be used to install sensors or other equipment such as, but not limited to, resonators, transducers, flow meters, hygrometers, and thermocouples to monitor various conditions within the drying chamber. The drying chamber 102 can also include exterior walls 214 that are secured to the vertical distribution plates 202a/b.

Note that the description of the distribution plates as “horizontal” and “vertical” is intended to describe the embodiment shown in FIG. 2. One skilled in the art should recognize that the descriptors of “horizontal” and “vertical” should not interpreted to limit the claims because other embodiments of the distribution plates may have an unlimited variety of channel configurations capable of distributing fluid between the distribution plates

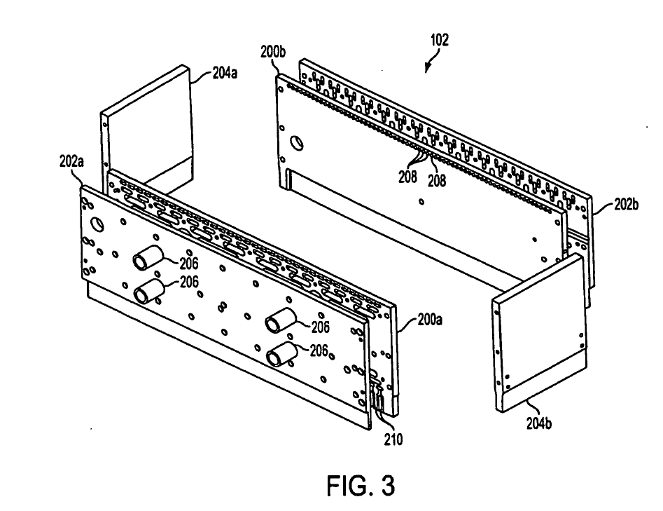

FIG. 3 is an exemplary illustration of an exploded view of a portion of drying chamber 102 in accordance with one embodiment of the present invention. Vertical grooves can be seen on a surface of the vertical distribution plate 202b. Similarly, horizontal grooves can be seen on a surface of horizontal distribution plate 200a. Also visible on horizontal distribution plate 200a are ports 210 that in this embodiment are diagonally opposed to ports 208. Depending on the type of flow desired within the chamber, the ports 208 and the ports 210 can be placed in a variety of positions. In other embodiments, additional ports or fewer ports can be used to distribute various fluids to the chamber. In the embodiment shown in FIG. 3, Ports 210 can distribute fluids to an area below the drying chamber 102. Ports 210 can also be found on horizontal distribution plate 200b but are not visible in FIG. 3.

In one embodiment, ports 206 are used to supply and return fluids that are distributed via the vertical and horizontal channels to/from ports 210 and ports 208. In other embodiments, a vacuum can be drawn through ports 206 thereby using ports 208 and ports 210 to evacuate fluids from the chamber. In other embodiments, various configurations within the vertical and horizontal distribution plates along with various configurations of fluid supply and vacuum through ports 206 can allow both fluid removal and fluid distribution through ports 208 and/or ports 210.

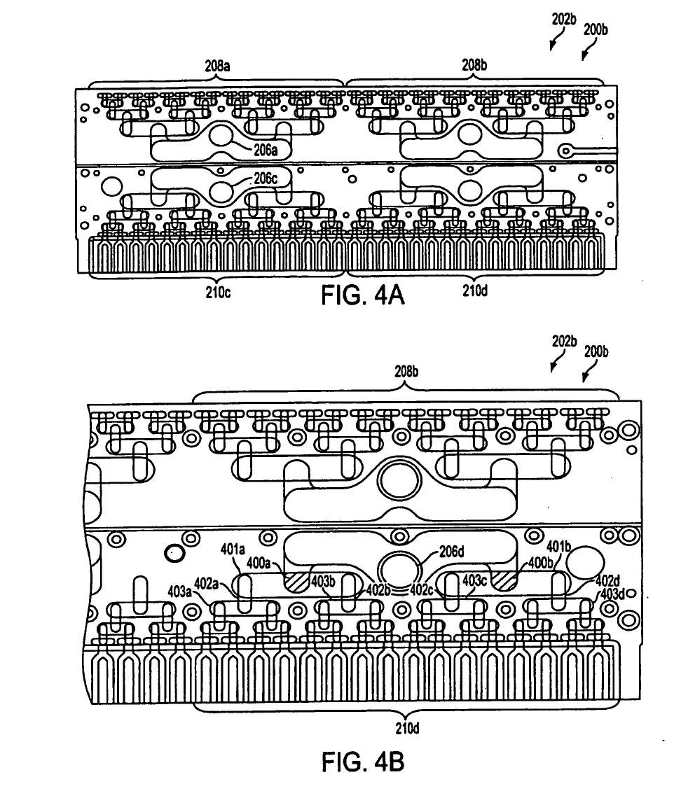

FIGS. 4A and 4B are exemplary views of the alignment of the vertical and horizontal channels of the vertical distribution plate 202b and the horizontal distribution plate 200b in accordance with one embodiment of the present invention. In this view, the horizontal distribution plate 200b has been made semi-translucent in order to see features of the vertical distribution plate 202b. In this embodiment, ports 206a-206d provide access to the distribution network formed by intersections between the horizontal distribution plate 200b and the vertical distribution plate 202b. As seen in FIG. 4A, port 206a provides fluid distribution and/or return to the plurality of ports 208a. Likewise, ports 206b-206d can provide fluid distribution and/or exhaust to the respective ports 208b and ports 210c/d.

FIG. 4B illustrates additional details of the right side of the horizontal and vertical distribution plates shown in FIG. 4A. Fluid introduced through port 206d passes through a volumetric area created by the intersection between the channels of the horizontal distribution plate 200b and the vertical distribution plate 202b. Intersecting areas 400a/b allow the fluid to split into two separate horizontal channels in the horizontal distribution plate 200b. In one embodiment, a summation of the cross-sectional area of a row of channels will result in substantially equal numbers for every row within the horizontal distribution plate 200b. Similarly, the sum of the cross-sectional areas of the vertical channels remains substantially equal for vertical distribution plate 202b. Maintaining a same cross-sectional area between the rows of horizontal and vertical channels promotes uniform fluid flow to all of the ports 208 and 210.

Looking at the distribution network associated with port 206d, intersecting the two horizontal channels 401a/b are four vertical channels 402a-402d that transport the fluid to four horizontal channels 403a-403d. In some embodiments, horizontal channels 401a/b can be viewed as a row of horizontal channels while vertical channels 402a-402d can be viewed as a row of vertical channels. Similarly, horizontal channels 403a-403d can also be viewed as a row of horizontal channels. Thus, the distribution network can be viewed as a collection of intersecting vertical and horizontal rows. In the embodiment illustrated in FIG. 4B, the distribution network associated with port 206d can be viewed to have five rows of horizontal channels and five rows of vertical channels (including the ports 210d). This is slightly different than the distribution network associated with ports 208b that have five rows of horizontal channels and four rows of vertical channels.

As previously described, the sum of the cross-sectional areas for horizontal channels 401a/b is approximately equal to the sum of the cross-sectional area of horizontal channels 403a-403d. The fluid that passes through port 206d continues to be split vertically and horizontally until the fluid is evenly distributed across a specified length of the drying chamber. In this example, the fluid introduced through port 206d, eventually emerges from ports 210d and the sum of the cross-sectional area of ports 210 would be approximately equal to the sum of the cross-sectional area of horizontal channels 401a and 401b.

In some embodiments, summing the cross-sectional areas of each of the ports 210d could result in the cross-sectional area of the port 206d. In other embodiments, fluids can be removed through port 206d and the distribution network formed between the horizontal distribution plate 202b and the vertical distribution plate 200b would evenly remove fluid from across the specified length of the chamber.

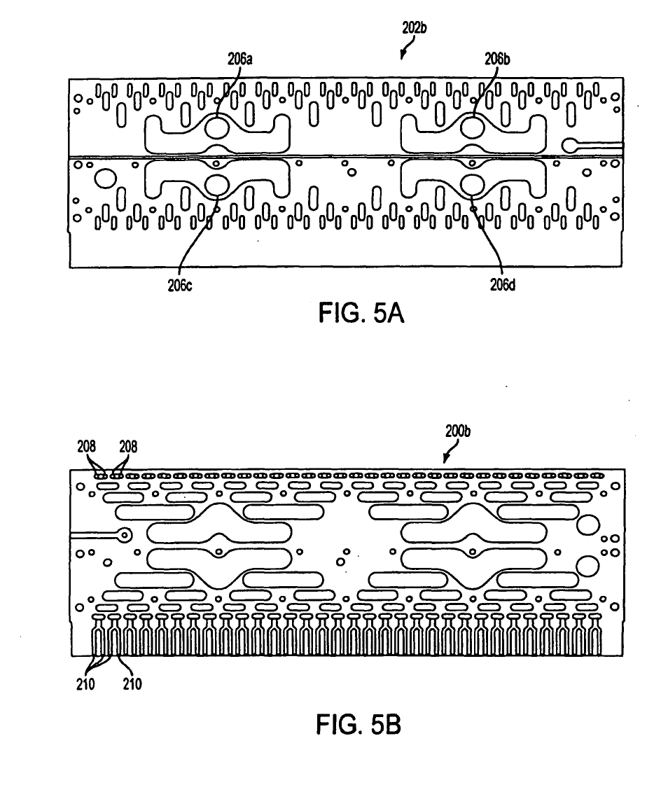

FIGS. 5A and 5B are schematics showing the vertical distribution plate 202b and the horizontal distribution plate 200b respectfully in accordance with one embodiment of the present invention. Separating the vertical distribution palate 202b and the horizontal distribution plate 200b, the cascading nature between the vertical and horizontal channels is evident. The cascading nature of the channels can also enable conservation of energy in chambers where heated or cooled fluids are flowing in and out of the chamber. In embodiments where fluid is input to the chamber, the conservation of energy within the chamber is promoted by transferring some of the incoming fluid energy to the chamber walls.

In embodiments where fluid is evacuated from the chamber using a vacuum, some of the outgoing fluid energy can be transferred to the chamber walls.

As illustrated in FIGS. 5A and 5B, the ports 206a-206d are on an opposite plate than ports 210 and/or ports 208. However, in other embodiments, where space constraints may be an issue, the horizontal and vertical channels can be configured so ports 206a-206d can be located on the same distribution plate as ports 210 and/or 208. In either embodiment, space saving and a reduction of an overall footprint of the chamber can be realized by placing input/output hardware necessary for ports 206a-206d within the chamber footprint.

FIGS. 6A-6F are exemplary schematics illustrating various flow patterns that could be established within a chamber in accordance with embodiments of the present invention. In each of the figures the smaller diagrams on the left and right illustrate a type of connection to the ports feeding the distribution network. The various configurations shown should not be construed as limiting as various flow possibilities and port positions can be used to create endless flow configurations and flow patterns. One skilled in the art should also recognize that either gases or liquids could be supplied, distributed and/or returned within the distribution network. FIG. 6A illustrates a flow pattern that could be established by applying a vacuum to ports located on the bottom of a chamber and introducing fluid through ports at the top of the chamber. In this embodiment cross-flow can be established from the top of one side of the chamber to the bottom of the opposing side.

FIG. 6B illustrates a cross-flow pattern that could be established by applying a vacuum to one side of the chamber while supplying fluid to the opposite side of the chamber. FIG. 6C is another exemplary flow pattern that could be induced by applying various vacuum and fluid supplies to a chamber utilizing fluid distribution plates. In this embodiment, fluid can be supplied through the ports at the top of the chamber while a vacuum evacuates fluid from the bottom of the chamber.

FIG. 6D illustrates as exemplary flow pattern that can be created by not using all of the available ports. In this embodiment, the bottom ports on one side can be used to supply a fluid while the upper ports on the opposite side draw a vacuum. The ability to engage or disengage input and output from the chamber can provide flexibility and allow a single chamber to perform multiple processing operations. Additionally, the fluid distribution plates can be scaled to accommodate various size chambers including, but not limited to rooms within structures or even entire structures. In larger embodiments, where fabrication of the distribution plates from a single piece of material could be difficult, it may be necessary to use modular construction techniques in order to simplify the manufacturing process.

FIG. 6E illustrates an embodiment where an exemplary flow pattern is established to remove fluid from the interior of the chamber. Applying a vacuum to all or some of the lower ports can create such a flow pattern. In other embodiments, gravity can be used in place of a vacuum to draw fluid from the chamber.

FIG. 6F illustrates as exemplary flow pattern that can be created by not using all of the available ports. In this embodiment, the top ports on one side can be used to supply a fluid while the bottom ports on the same side are used to draw a vacuum. It should be appreciated that this scheme creates a C-loop flow pattern in the chamber that can enhance drying performance. In one embodiment, the C-loop pattern can be manipulated with regard to the width across the chamber covered by the C-loop through variation of the flow rates for the fluid being supplied to the top ports. For example, the flow rates can be adjusted between a maximum and a minimum to manipulate the reach of the C-loop across the width of the chamber.

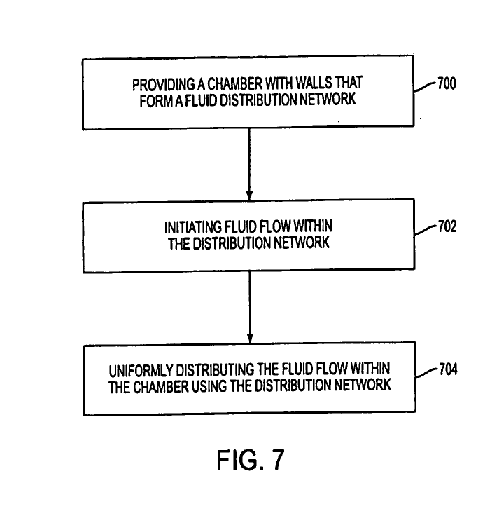

FIG. 7 is a flow chart illustrating exemplary operations for a method to evenly distribute a fluid within a chamber in accordance with one embodiment of the present invention. Operation 700 provides a chamber with walls that form a fluid distribution network. In one embodiment, the fluid distribution network can be formed between horizontal distribution plates and vertical distribution plates. As previously discussed, the distribution plates can have channels or grooves that intersect or overlap when affixed together to form the distribution network.

Operation 702 initiates fluid flow within the distribution network. As previously discussed, the fluid flow can be initiated via a port connected to the distribution network. In some embodiments, fluid can be input to the distribution network, while in other embodiments, fluid can be removed from the distribution network.

Operation 704 distributes the fluid flow within the chamber formed by the distribution plates. In some embodiments, the cascading nature of the distribution network can promote the even distribution of fluid. In some embodiments, the distribution network promotes even distribution of fluid within the distribution network by reducing cross-sectional area of the individual channels while increasing the number of individual channels to maintain a constant cross-sectional area for fluid to flow.

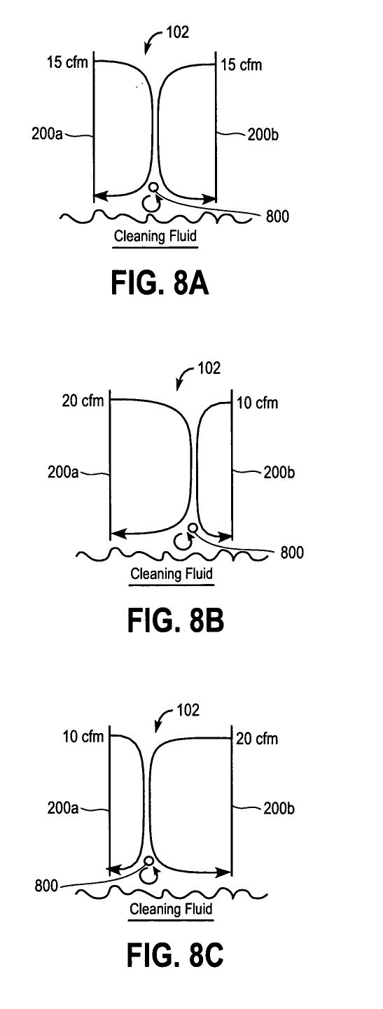

FIGS. 8A-C illustrate various embodiments for sweeping the flow paths of FIG. 6C to further optimize the drying process in accordance with one embodiment of the invention. In FIG. 8A the loop flow path from each of sidewalls 200a and 200b are provided such that the inlet for the fluid flow is one opposing top ports and the outlets are on opposing bottom ports. In one embodiment, the bottom ports are in fluid communication with a vacuum source. The loop flow configuration in this embodiment leaves dead zone in region 800. The dead zone in region 800 may be a flow eddy that does not allow the moisture removed from the disk or workpiece being dried to be carried away by the drying fluid. The flow eddy creates a high humidity area that prevents optimum drying of the disk in the vicinity of the flow eddy. FIGS. 8B and 8C provide for alternative embodiments where the dual fluid flows are swept across the cleaning fluid surface that drying chamber 102 sits above. As illustrated in FIGS. 8B and 8C the inlet flow rates for the fluid streams from the two sides of the drying chamber are alternated in order to sweep the flow across the surface of the cleaning fluid and the workpiece being dried. In the embodiments of FIGS. 8B and 8C, the flow rates supplied to each side are different in order to bias the flow towards the side of the chamber with the lower flow rate to enhance the drying performance.

It should be appreciated that the cleaning chamber described above with reference to

FIGS. 1-7 may be employed to provide the loop flow paths from opposing sidewalls illustrated in FIGS. 8A-C. However, the embodiments are not limited to the cleaning chamber described herein as other suitable chambers having the capability of providing the loop flow paths from opposing sides are possible. The loop flow paths may be created through any chamber having the top inlet ports and the bottom outlet ports described above.

In addition, it should be appreciated that the drying chamber may be exposed to the external environment at the top and the bottom of the chamber. That is, the top and bottom of the chamber may be open so that the disks or workpieces may be transferred through the chamber. As one skilled in the art would appreciate, the disks are lifted out of the cleaning fluid, which may be deionized water in one embodiment, and into the drying chamber. In the drying chamber the disks are dried through the loop fluid flow provided from opposing sides of the chamber. The disks may be supported on a nest, such as the nest described with reference to application Ser. No. 12/359,173, which is incorporated herein by reference for all purposes.

FIG. 9 is a simplified schematic diagram illustrating an exemplary implementation to achieve the dual flow paths that sweep across the drying chamber in accordance with one embodiment of the invention. Fluid source 900 provides a drying fluid, such as an inert gas, e.g., nitrogen, to mass flow controllers (MFCs) 902a and 902b. MFCs 902a and 902b provide the fluid to heaters 904a and 904b in one embodiment. From the heaters 904a and 904b, the fluid is provided to corresponding filters 906a and 906b, and subsequently delivered to drying chamber 102. In one embodiment the fluid is provided to the top ports of drying chamber 102, although the inlet ports and outlet ports from drying chamber 102 may be reversed in another embodiment. The fluid delivered to each side of drying chamber 102 creates dual fluid paths directed towards each other inside the drying chamber. As illustrated in FIG. 9 and FIGS. 8A-C, the dual fluid paths may be manipulated through the flow rates or exhaust rates as described herein. The outlets of drying chamber 102 are in fluid communication with flow control valves 908a and 908b. The flow control valves 908a and 908b are in fluid communication with vacuum sources 910a and 910b.

It should be appreciated that the embodiments of FIG. 9 illustrate dedicated mass flow controllers for each side of drying chamber 912, as well as dedicated flow control valves for each of the outlet ports. However, in alternative embodiments a single mass flow controller with dedicated flow control valves located downstream from the mass flow controller may be utilized to bias the inlet fluid flow. Alternatively, dedicated blowers for each inlet port side of drying chamber 102 may be integrated to bias the fluid flow. In addition, flow control valves 908a and 908b are optional in one embodiment. In any of these embodiments the dual fluid flow paths are biased as indicated by arrow 912 in order to sweep the fluid flows across a surface of a cleaning fluid over which drying chamber 102 is disposed. In one embodiment, the total flow of the drying fluid into drying chamber 102 is maintained constant, i.e., as the flow to one side is increased, the flow to the corresponding side is decreased by an equal amount. In another embodiment, the drying fluid is supplied to the drying chamber 102 from one side and leaves the drying chamber 102 from the same side, when there is not inlet/outlet flow from the other side of drying chamber 102. This creates a C-loop flow pattern as illustrated in FIG. 6F. One skilled in the art will appreciate that the same concept may be applied to the outlet rate of exhaust when the flow control valves are controlling the flow rates to bias the dual looped flows.

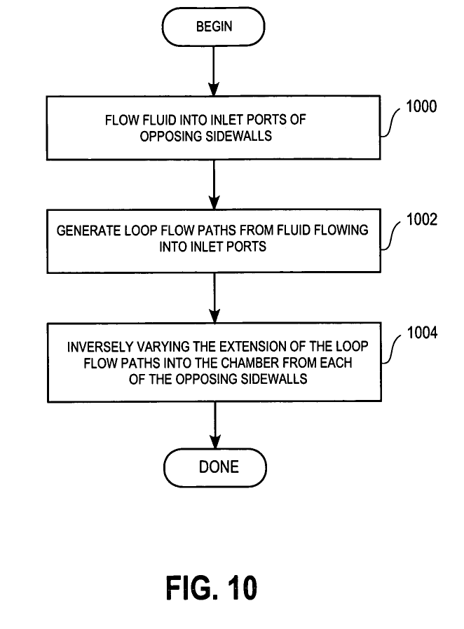

FIG. 10 is a flow chart diagram illustrating the method of operations for distributing fluid into a drying chamber disposed over a cleaning fluid in accordance with one embodiment of the invention. The method initiates with operation 1000 where fluid flows into inlet ports of opposing sidewalls of a chamber. As discussed with reference to FIG. 9, the fluid flow may be supplied through independent mass flow controllers or removed with independent blowers. Alternatively, a single supply may provide the fluid flow to the opposing sides and the different flows to each side of the drying chamber may be achieved through manipulation of control valves located on either the supply or the exhaust sides. The method then advances to operation 1002 where a loop flow path of the fluid that extends into the chamber from each of the opposing sidewalls is created. The loop flow path from each side, also referred to a “C” loop flow, is illustrated with reference to FIGS. 6C, 6F and 8A-C. This loop flow path is generated through the top inlet ports and the bottom outlet ports as illustrated above. In operation 1004 the extension of the loop flow paths into the chamber are inversely varied to sweep the dead zone back and forth across the surface of the cleaning fluid or bias the flow toward one side of the chamber.

In one embodiment, the inlet and/or outlet of one side of the drying chamber may be shut, while the other side is fully open in order to maximize the fluid velocity above the cleaning fluid surface as shown in FIG. 6F. Alternatively, the flow rates may be alternated over time to each of the sides. As mentioned above, the flow rates may be manipulated through control valves on either the supply or exhaust sides in one embodiment. In another embodiment, the fluid flow on the supply side may be manipulated or varied through the mass flow controllers to sweep the dead zone across a width of the chamber. Thus, through the embodiments described herein, the sweeping of the dead zone back and forth across a region in the vicinity of the cleaning fluid air interface enhances the drying process. The biasing of the flow towards one side of the drying chamber also provides enhanced drying as the dead zone is not in the vicinity of the disk/workpiece surface. Shutting down the inlet/outlet ports on one side, as illustrated in FIG. 6F, would prevent the formation of the dead zone while allow for higher flow velocity, and consequently enhance drying performance, in the vicinity of disk/workpiece, above the cleaning fluid surface.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for distributing a fluid, comprising:
flowing fluid into inlet ports of opposing sidewalls of a chamber;
creating a loop flow path of the fluid that extends into the chamber from each of the opposing sidewalls; and
inversely varying an extension of the loop flow paths into the chamber.

2. The method of claim 1, wherein the inversely varying flow sweeps a flow dead zone across lower region of the chamber.

3. The method of claim 1, wherein each loop flow path returns to outlet ports of a sidewall where the loop flow path originated.

4. The method for claim 1, wherein each method operation is performed while a plurality of workpieces is supported within an interior of the chamber.

5. The method of claim 1, further comprising:
lifting a plurality of workpieces from a fluid bath disposed below the chamber through a bottom opening into an interior of the chamber.

6. The method of claim 1 wherein the inversely varying includes one of adjusting flow control valves in fluid communication with outlet ports of opposing sidewalls inversely or flow rates to the inlet ports inversely, or a combination of the adjusting flow control valves and flow rates.

7. A chamber, comprising:
a first wall and an opposing second wall, each wall having an interior surface, each interior surface including a plurality of interior ports in fluid communication with an outlet port of the chamber; and
a first flow controller and a second flow controller controlling a fluid flow to the interior ports through the outlet port, wherein the first and second flow controllers each provide a loop flow path from the interior ports of the first and second walls, the loop flow paths inversely varied across an interior width of the chamber such that a zone preventing moisture removal is moved as the loop flow paths are inversely varied through the first and the second flow controllers.

8. The chamber of claim 7, further comprising a vacuum source in fluid communication with a second set of a plurality of interior ports.

9. The chamber of claim 8, wherein the plurality of interior ports are located above the second set of the plurality of interior ports and wherein the loop flow path extends outward from one of the plurality of interior ports and returns inward to one of the second set of the plurality of interior ports.

10. The chamber of claim 8, wherein the chamber is disposed over a fluid bath and the interior of the chamber is exposed to a surface of the fluid bath, and wherein a top of the chamber is open.

11. The chamber of claim 8, wherein a total flow rate applied through the first and second flow controllers remains constant as the individual flow rates from the flow controllers vary.

12. The chamber of claim 8, wherein the loop flow paths for the first wall enter and exit the interior of the chamber from the first wall and wherein the loop flow paths for the second wall enter and exit the interior of the chamber from the second wall.

13. The chamber of claim 8 wherein the fluid is an inert gas and wherein a heater and filter are disposed downstream from each of the flow controllers.

14. A drying system, comprising:
a chamber having first and second sidewalls and first and second end walls affixed to the first and second sidewalls, wherein interior surfaces of the first and second sidewalls have a plurality of inlet ports along an upper region of the interior surfaces and a plurality of outlet ports along a lower region of the interior surfaces;
a fluid source in fluid communication with inlet ports of the first and second sidewalls;
a vacuum source in fluid communication with outlet ports of exterior surfaces of the first and the second sidewalls, the inlet ports of the first and second sidewalls in fluid communication with the plurality of inlet ports along the upper region of the interior surfaces, the outlet ports of the first and the second sidewalls in fluid communication with the plurality of outlet ports along the lower region of the interior surfaces, wherein a loop fluid flow is provided from each of the sidewalls, the loop fluid flow from the sidewalls flowing toward an opposing loop fluid flow in an upper region of the chamber and away from each other in a lower region of the chamber.

15. The drying system of claim 14, wherein a first and second flow control valve is disposed between the vacuum source and corresponding first and second sidewalls.

16. The drying system of claim 15, wherein a rate of fluid flow through the plurality of inlet ports along the upper region of the interior surfaces is independently controlled by the first and the second flow control valves.

17. The drying system of claim 14, further comprising:
a first flow controller and a second flow controller controlling a fluid flow to the inlet ports, the first and second flow controllers located between the fluid source and corresponding first and second sidewalls.

18. The drying system of claim 16, wherein an extension of the loop fluid flow and an extension of the opposing loop fluid flow into an interior region of the chamber is varied inversely through the first and the second control valves.

19. The drying system of claim 14, wherein the chamber is disposed over a fluid bath and wherein a top and a bottom of the chamber are open.

20. The drying system .of claim 17, wherein a fluid from the fluid source is an inert gas and wherein a heater and filter are disposed downstream from each of the flow controllers.
